(19) United States
(12) Patent Application Publication
(10) Pub. No.: US 2019/0333365 A1
(43) Pub. Date: Oct. 31, 2019

(54) STIMULUS GENERATING APPARATUS

(71) Applicant: SATA LIMITED, Welham Green, Hertfordshire (GB)

(72) Inventors: STEVE BASFORD, WELHAM GREEN, HERTFORDSHIRE (GB); ALLEN STUART, WELHAM GREEN, HERTFORDSHIRE (GB); NEIL WILLIAMS, WELHAM GREEN, HERTFORDSHIRE (GB)

(21) Appl. No.: 16/310,509

(22) PCT Filed: Jun. 13, 2017
(86) PCT No.: PCT/GB2017/051713

§ 371 Date: Dec. 17, 2018

(30) Foreign Application Priority Data
Jun. 17, 2016 (GB) 1610643.7

(51) Int. Cl. G08B 29/14

(52) U.S. Cl. CPC G08B 29/145

(57) ABSTRACT

An apparatus for generating a test stimulus for testing a hazard detector is provided, the apparatus comprising: a porous material for receiving a vaporisable test medium that is to be transported to surface of the porous material for vaporisation; and an electrical heating device for heating the test medium on the surface of the porous material to generate a test stimulus for testing a hazard detector further comprising a tube which carries the test medium and wherein the porous material forms at least part of the tube. Also provided is a testing apparatus for testing a hazard detector, comprising a dispenser comprising a pole, the dispenser further comprising a compartment for receiving the aforementioned generating apparatus, wherein the generating apparatus is in the form of a module received in the compartment.

The present invention relates to apparatus for generating stimulus and particularly the generation of stimulus for testing hazard detectors such as smoke, heat or carbon monoxide (CO) detectors and more particularly to a generator for generating a test stimulus.

Hazard detection systems can utilise a variety of sensors to detect hazards, including smoke sensors, heat sensors, gas sensors, etc. Equipment to carry out functional testing of different types of hazard detector is already available worldwide, and a well-known brand is ‘SOLO’ test equipment. In such equipment, test stimulus is designed to replicate the hazard in a non-hazardous fashion (e.g. heat, simulated smoke), so that the correct operation of the detector and/or the system can be verified without the risk of duplicating the real hazard (e.g. a real fire).

For smoke detectors (or fire detectors that incorporate smoke sensors), a common test medium is a cloud of aerosol particulate which simulates real smoke. It can be deployed from an aerosol can into the detector, often using a special dispensing tool, so that the operation of the smoke detector and its role within the fire detection system is checked. Also, in all types of hazard detector testing, the test stimulus should ideally be introduced into the detector from outside it, i.e. from the surrounding air, so as to ensure that the entry path to the sensor is not blocked in any way, impeding the ability of the detector to react properly to the hazard. Specifically, this type of functional testing of fire detectors is well approved and respected as a good and necessary test of the functioning of such a hazard detector. Indeed, it is mandated in many national Codes of Practice and Regulations around the world.

By contrast, other test methods which do not include the application of stimuli to the sensors from outside the detector are not widely approved, and indeed are actively prohibited by many test standards. These methods include testing using a magnet which is held close to the detector body, thereby closing a reed switch internally to complete an electrical circuit which simulates an alarm state, or the testing of a detector for function by means of its internal electronic behaviour only, often done remotely from the control and indicating equipment to which the detector is connected. These methods are not deemed to be sufficient to satisfactorily test the entire operation of the detection device. For example, it may be possible for a hazard detector to have a protective dust cover installed over it, thereby preventing the products of a real hazard from entering its sensors, and yet electrically it may appear to be fully functional and capable of detecting a hazard.

There is a move away from the use of pressurised aerosol canisters for a number of reasons and the inventors have arrived at a new apparatus for generating one or more stimuli for functional testing of a hazard detector.

From a first aspect, the present invention provides an apparatus for generating a test stimulus for testing a hazard detector, the apparatus comprising: a porous material for receiving a vaporisable test medium that is to be transported to surface of the porous material for vaporisation; and an electrical heating device for heating the test medium from the porous material to generate a test stimulus for testing a hazard detector. The apparatus further comprises a tube which carries the test medium and wherein the porous material forms at least part of the tube.

The apparatus may further comprise: means for receiving a container containing a source of vaporisable test medium; and means for delivering the test medium to the porous material.

One end of the delivering means may be in contact with the source of vaporisable test medium and the other end is attached to the porous material such that test medium from the source of test medium is delivered to the porous material. The electrical heating device can be coupled to the porous material in order to heat the test medium received by the porous material and the test medium can be transported to the surface of the porous material upon activation of the heating device.

The porous material is preferably electrically non-conductive but thermally conductive and the porous material may be fibreglass or ceramic.

The electrical device may comprise an electrically conductive wire wound around an outer surface of the porous material. Therefore, in this embodiment, there is direct contact between the wire and the outer surface of the porous material.

From another aspect, the present invention can provide a corresponding method of generating a test stimulus for testing a hazard detector, the method comprising: receiving a vaporisable test medium in a porous material, transporting the vaporisable test medium to surface of the porous material for vaporisation; and heating the test medium from the porous material to generate a test stimulus for testing a hazard detector.

A testing apparatus may comprise a dispenser having a compartment for receiving the generating apparatus that is modular. The dispenser may further comprise a fan which is adapted to influence the flow of the test stimulus and a battery compartment for receiving a battery.

In one embodiment the testing apparatus is intended to test hazard detectors which are still in situ, for example, on the ceilings of public buildings. Such detectors are sometimes hard to reach. In this particular embodiment, the apparatus is designed to reach these detectors by being mounted on a pole. Power may be made available to the testing apparatus, even while operating at the top of the pole many metres from the ground. Alternatively, the testing apparatus may itself be located on the ceiling. For example, the testing apparatus may be positioned next to a detector and be provided with means to move the generated stimulus into the vicinity of the detector. Another possibility is that the testing apparatus may be located in the same unit as the detector itself and in either event, the testing apparatus may receive its power through a connection in the ceiling.

In order that the present invention is more readily understood, embodiments will now be described by way of example only with reference to the accompanying drawings in which:

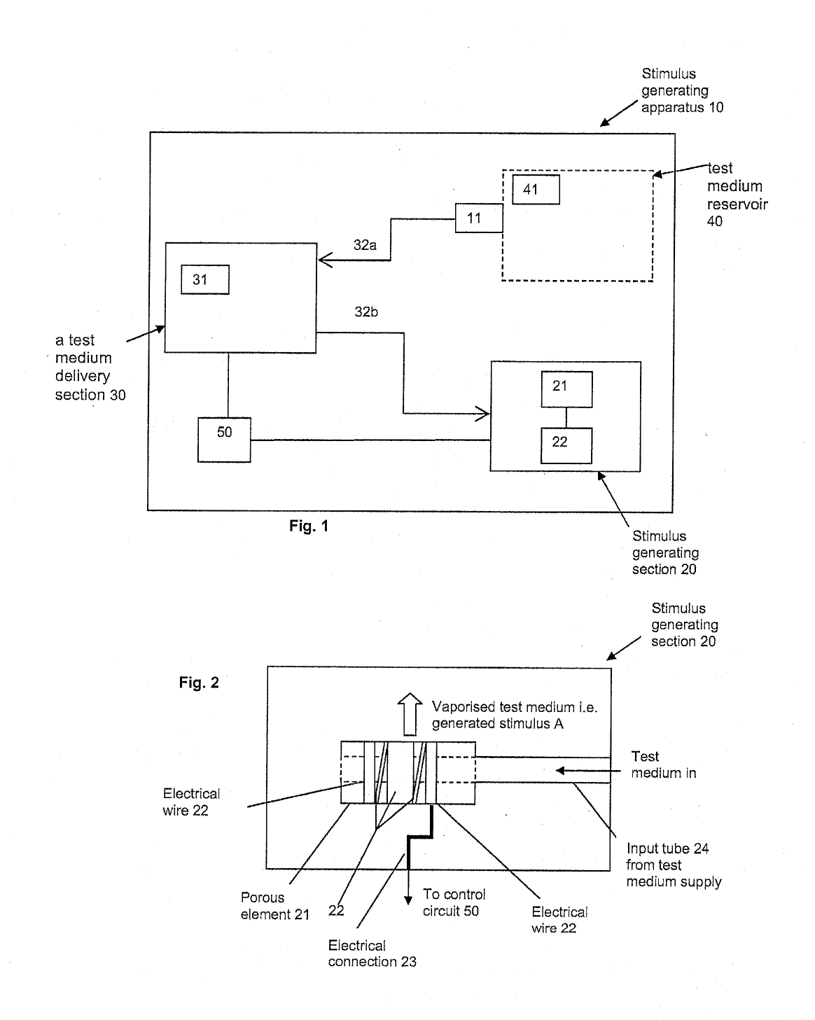

FIG. 1 shows a schematic diagram of the generating apparatus according to an embodiment of the invention;

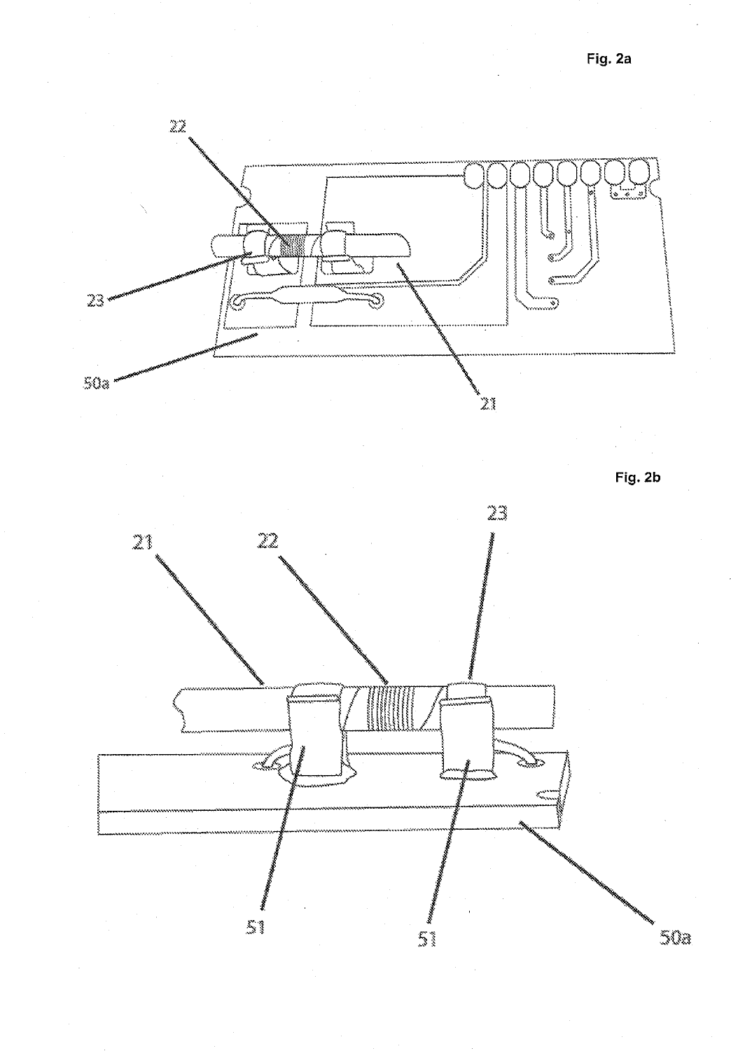

FIG. 2 is a schematic diagram of the stimulus generating section of the generating apparatus of embodiment of FIG. 1, FIG. 2a shows a perspective view of part of the stimulus generating section and FIG. 2b shows a view from a side of the porous element shown in FIG. 2a;

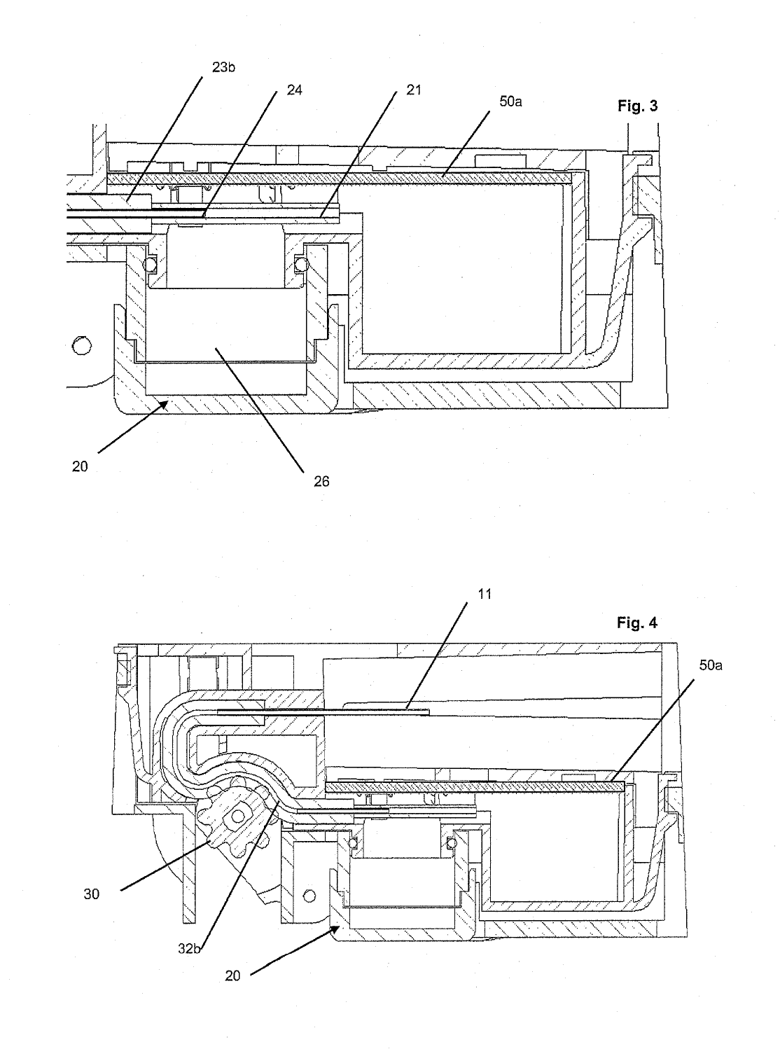

FIG. 3 is a cutaway view of part of a generating apparatus according to the embodiment of FIGS. 1 and 2;

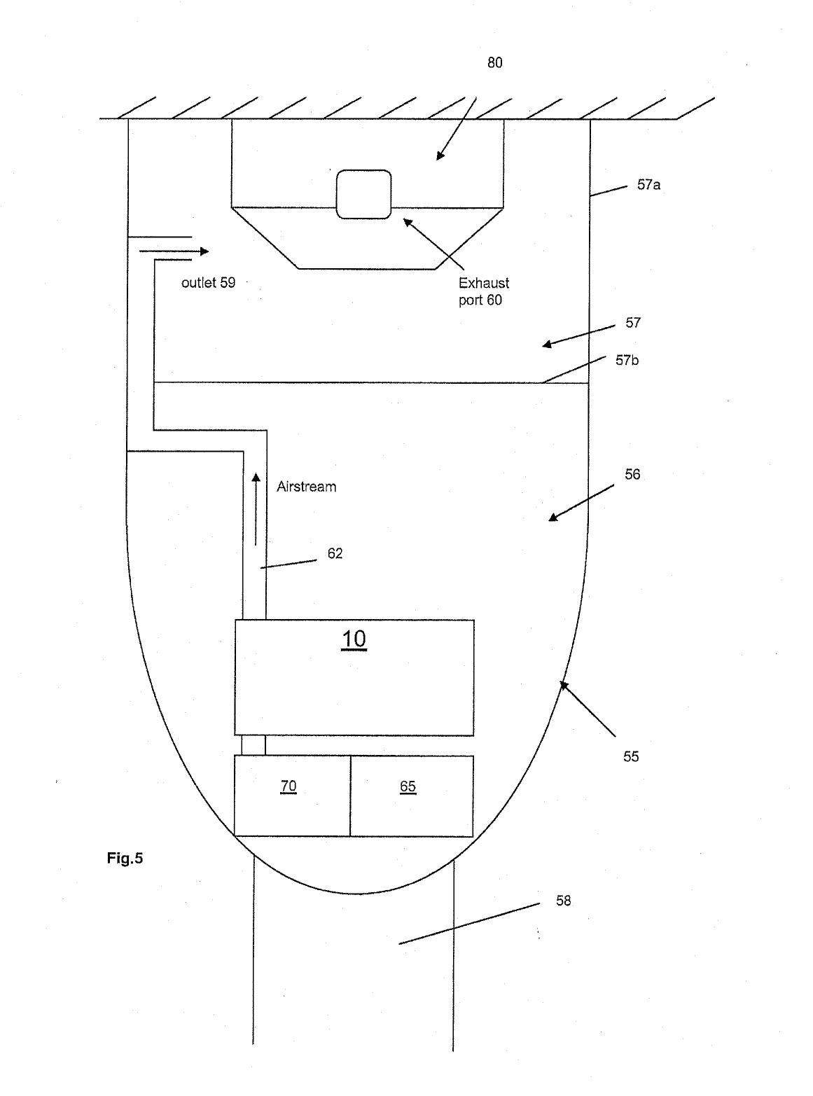

FIG. 4 is a cutaway view of the generating apparatus according to a second embodiment showing a stimulus generator section, test medium delivery section, and piercing tube;

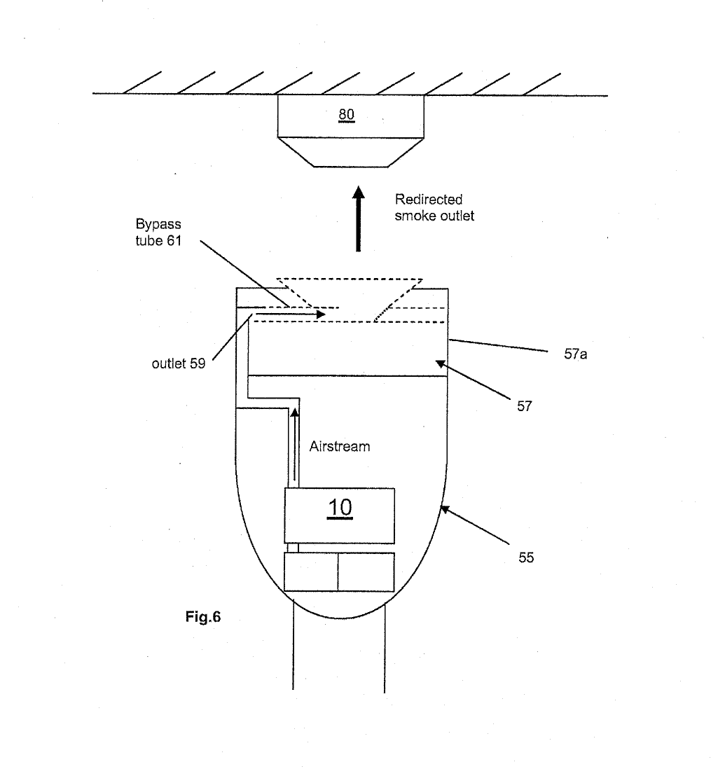

FIG. 5 shows a dispenser apparatus that can receive the generating apparatus of the first or second embodiment;

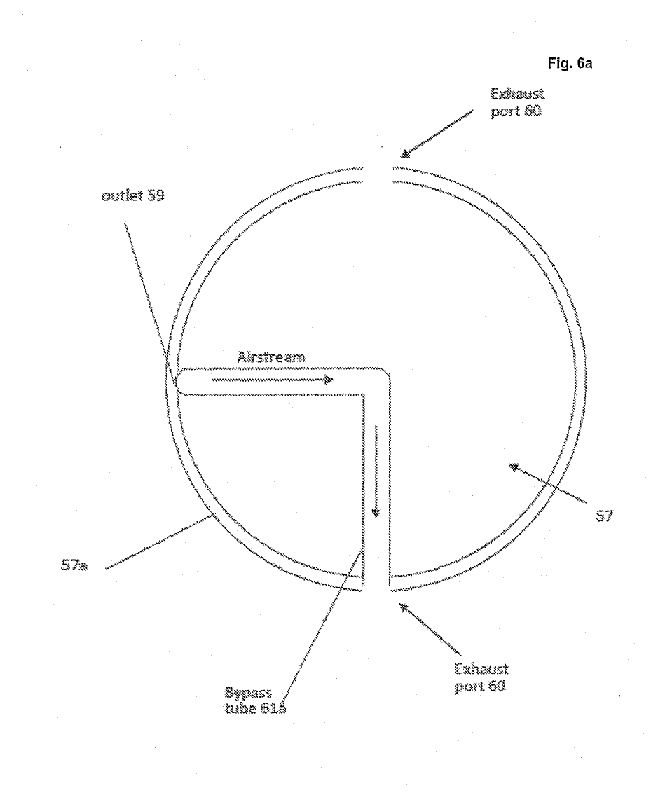

FIG. 6 shows the dispenser apparatus of FIG. 5 with a bypass tube, FIG. 6a shows a top view of the dispenser including an alternative configuration of bypass tube.

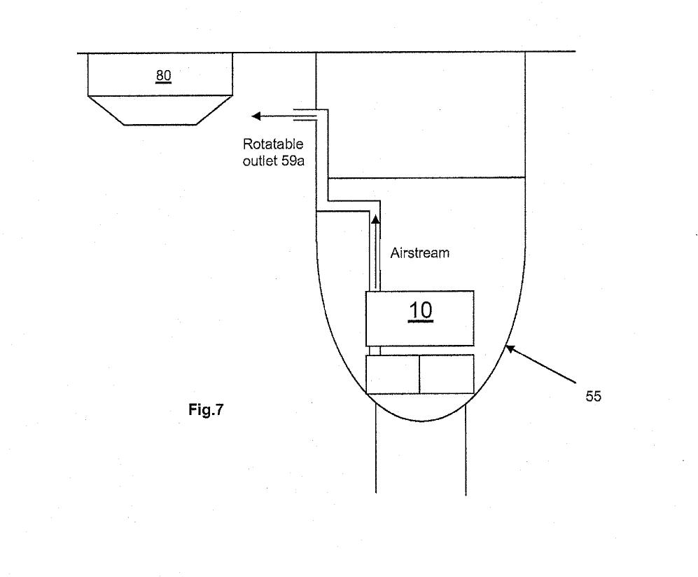

FIG. 7 shows an alternative dispenser apparatus to that shown in FIG. 5 with a rotatable outlet.

Referring now to FIG. 1 which shows a schematic diagram of an apparatus according to a first embodiment of the invention. It will be appreciated that this diagram is representative of the apparatus and its various components and is not limiting on the structure of the apparatus and arrangement of its components.

An apparatus 10 for generating a test stimulus that is used to test a hazard detector (an example hazard detector is shown in FIGS. 5, 6 and 7) can comprise a stimulus generating section 20 and a test medium delivery section 30. For the purposes of the description, a hazard detector can be any type of gas or combustion product detector such as a smoke detector which can detect the presence of a gas or combustion product such as smoke. Such a hazard detector would be known to the skilled person in the art.

The test medium delivery section 30 receives the test medium from a test medium reservoir 40. Stimulus generating section 20 can be operable to generate test stimulus from the test medium. It will be appreciated by the skilled person that test medium is provided in the stimulus generating section either from a separate source such as the test medium reservoir 40 or through some other means which may be provided in the stimulus generating section itself.

In this embodiment, the generating apparatus 10 includes a piercing tube 11 to connect to the test medium reservoir 40. The test medium reservoir 40 is a replaceable modular cartridge in this embodiment that is removeably attached to a section of the generating apparatus 10. The output of the cartridge includes a membrane that can be pierced by the piercing tube 11 and that prevents release of medium from the cartridge when the cartridge is not connected to the piercing tube 11. The piercing tube 11 receives test medium 41 from the cartridge and transfers the test medium 41 through a tube 32a. The use of a suitable pump (described below) to extract the test medium causes the test medium reservoir to collapse under atmospheric pressure. Alternatively, however, the test medium 41 may be under pressure in the reservoir through other means and the test medium can be forced out of the reservoir under pressure.

The stimulus generating section 20 (explained in more detail below) is adapted to receive a test medium 41 from the test medium reservoir 40 via the test medium delivery section 30 and to generate stimulus which is representative of a gas and/or combustion product for testing the hazard detector. A porous body 21 is provided in the stimulus generating section 20 to receive some of the test medium 41 from the test medium reservoir 40 and is connected to an electrical heating element 22 which can heat the test medium 41 received by the porous body 21.

The test medium delivery section 30 is positioned between the stimulus generating section 20 and the test medium reservoir 40. It is operable to transfer test medium 41 from the test medium reservoir 40 to the stimulus generating section 20 by any suitable means. In this embodiment, a pumping apparatus 31 is provided which can be a piezoelectric pump or peristaltic pump. A control circuit 50 is provided in the apparatus 10 to control the activation of the pumping apparatus 31 and therefore can electronically control the delivery of the test medium 41 from the reservoir 40.

The test medium delivery section 30 further comprises delivery medium such as one or more tubes 32 that deliver the test medium 41 to the stimulus generating section 20. In this embodiment, the tube 32a is connected between the test medium reservoir 40 and the pumping apparatus 31 and tube 32b is connected between the pumping apparatus 31 and the stimulus generating section 20.

In one embodiment, as shown in FIGS. 2, 2a, and 2b, the stimulus generating section 20 comprises a porous body 21 and a heating element which in this embodiment is an electrically conductive wire 22 that is in contact with the outer surface of the porous body 21. Electrical current passes through the wire 22 which results in heating of the wire 22 and thus the test medium 41 on the surface of the porous body 21.

In this embodiment, the porous body 21 is an electrically non-conductive hollow tube that receives the test medium 41 on the inside through a side aperture and is formed of ceramic. It will be appreciated that in other embodiments the porous body may be formed of fibreglass. The body 21 is porous in that there are minute holes in body 21 that enable fluid to be transferred generally laterally in relation to the central longitudinal axis of the tube. Liquid within the hollow tube can be transferred through the porous body 21 to the outer surface of the tube. The electrically conductive wire 22 (or other appropriate heating element) is in direct contact with the liquid due to the action of the porous body 21 which has brought the liquid out through its walls to come into direct contact with the electrically conductive wire 22.

The electrically conductive wire 22 is self-heating in the sense that it generates heat when a current is passed through it. It is self-heating because heat is not applied to it. Rather, electrical power is applied to the wire to generate the heat. The wire 22 is wound around the porous body 21. In another embodiment (not shown), heating element may be arranged within a thermally conductive porous body such that heat is provided inside the porous body rather than directly to the outer surface of the porous body 21.

Referring to FIGS. 3 and 4, the porous body 21 is connected to an input tube 24 of the stimulus generating means 20 that is connected to tube 32b from the test medium delivery section 30. The input tube 24 can deliver test medium 41 to approximately the centre of the hollow porous body 21. Test medium 41 is pumped by the test medium delivery section 30 into the porous body 21. One end of the input tube 24 is directly coupled to one side of the porous body 21 or a portion of one side of the tube may be received within the hollow part of the porous body 21 as shown in FIGS. 3 and 4.

The wire 22 is connected to a control circuit 50 through a electrical connection 23 and, in the embodiment shown in FIG. 2, the electrical connection is in the form of soldering to conductive clips 51 onto a PCB 50a which connects to the control circuit 50 which in one embodiment is a separate printed circuit board. This can provide a compact arrangement. The porous body 21 is mounted securely on the printed circuit board 50a using the conductive clips 51 such that inverting of the generating apparatus maintains the connection between the porous body 21 and the electrical connection 23. The conductive clips 21 are U-shaped and upstanding from the surface of the PCB 50a. Although the embodiment described and shown is particularly advantageous, it will be appreciated that other arrangements (not shown) are envisaged, for example, to mount the porous element to the PCB and to provide the electrical connection between the wire and the control circuit. In particular, other mechanisms instead of conductive clips may be used to mount the porous element and provide the electrical connection to the wire. For example, the wire may be connected directly to the control circuit without using conductive clips to provide a electrically conductive interface between the wire and the control circuit.

In use, the test medium 41 is transferred to the generating section 20 upon activation of the electronically controlled test medium delivery section 30 and simultaneously, prior to, or after a short delay, the heating element is activated and the test medium 41 in the porous body 21 is heated thereby generating test stimulus A from the test medium 41. The test stimulus A is collected in an accumulation area 26 of the generating section 20 for delivery to the hazard detector. In this embodiment, given that the porous body 21 is a good thermal conductor, heat can be spread efficiently across the surface of the body 21 for better stimulus production. Also, it is safe as it is not capable of sustaining a flame due to its high thermal mass (i.e. takes a lot of energy to heat/cool) given the chosen properties of the test medium 41. The porous element cannot start a flame due to the fact that it cools faster than the combustion can heat it. It would need to be above a certain temperature in order to continue burning and the temperature can be determined in part by the test medium composition/formulation. The test medium 41 is pumped into the hollow portion of the porous body 21 through a side aperture hence containing the test medium within the body 21.

The electronically controlled test medium delivery section 30 which includes the positive displacement pump 31 pumps the test medium into the porous body 21.

Referring now to FIGS. 5, 6 and 7, a stimulus dispenser 55 will be described in connection with the generating apparatus 10. The combination of the stimulus dispenser and generating apparatus will be referred to as a test apparatus as both devices can contribute to carrying out a functional test on a detector. The generating apparatus 10 is a removable module which is received in a compartment in the stimulus dispenser housing section 56. As is apparent from the above, the generating apparatus 10 is electronically controlled.

Depending on the test medium, the test stimulus will test an appropriate hazard detector. In one embodiment, stimulus dispenser 55 is a synthetic smoke dispenser for testing a smoke detector 80. The stimulus dispenser 55 has an open-topped housing. The detector 80 is received in a cavity section 57 in the housing of the stimulus dispenser 55, the section having a cavity that is formed within a sidewall 57a and a bottom 57b. The sidewall 57a may be transparent or translucent. When the top of the sidewall 57a abuts a planar surface such as a ceiling, for example, a chamber is formed in the cavity section 57 within which stimulus can be introduced.

In this embodiment the stimulus dispenser 55 is of a type which is portable and is capable of being mounted on the end of a pole 58 so as to be lifted into the test condition by an operator standing on the ground while the detector 80 under test is located on, for example, a ceiling. The dispenser 55 is designed to cause a sample of test stimulus to be emitted in the vicinity of a detector 80 under test to cause the detector to be activated. It may be tilted to access detectors in awkward positions, or even inverted during use.

A battery 65 and fan blower 70 may be located adjacent the generating apparatus 10 in the stimulus dispenser housing. The battery may be rechargeable. The fan blower 70 is located upstream of the generating section 20 and arranged to blow the generated stimulus from the accumulation area 26 of the generating section 20 to an outlet 59 of the stimulus dispenser 55, the outlet 59 being preferably horizontally directed and located downstream of the generating section 20. The accumulation area 26 (shown in FIG. 3) is part of a sealed air duct connected to the fan blower 70 such that air from the blower 70 passes through the accumulation area 26 and then to the outlet 59 of the stimulus dispenser 55.

When a test is to be carried out, the test apparatus will enter a test mode where stimulus produced by the generator apparatus 10 passes through delivery duct or ducts 62 under the action of the fan blower 70 to outlet 59. It will be appreciated that multiple outlets may be provided. The delivery duct 62 and outlet 59 can deliver the stimulus to the exterior of the stimulus apparatus 55. The fan blower 70 and the stimulus generating apparatus 10 are electrically powered from the battery 65 as a power source which may be in the form of a primary dry cell battery or a rechargeable secondary cell or the like. The battery can be replaced through an appropriate release mechanism (not shown) if required. The electrical supply from the battery 65 to the fan 70 and generating apparatus 10 is by way of an electrical switching device (not shown) which is actuable mechanically from outside the stimulus apparatus 55, internally from non-contact means such as a proximity sensor or which is controlled remotely to cause activation of a test.

The test apparatus can also be operable to enter a clearing mode to ensure that recently-produced stimuli is expelled away from the detector quickly and hence enable prompt reset of the hazard detection system. In this embodiment, only the fan blower 70 (and not the generating apparatus 10) need be activated such that flow of air through the duct 62 causes air to exit through the outlet 59 and clear the stimulus from the detector 80 after a test is performed. It will be appreciated that a separate duct or channel (not shown) may be provided in the stimulus apparatus 55 between the fan blower 70 and the outlet 59 or another outlet, the duct or channel bypassing the generator apparatus 10 to blow clean air and clear stimulus from the detector 80. The fan blower 70 can be selectively controlled depending on the mode. The electrical switching device can be controlled to activate the different modes of the apparatus.

The outlet 59 is in the cavity section 57 and an exhaust port 60 is located in the cavity section 57 of the stimulus dispenser 55 to allow any excess generated stimulus to be exhausted from the cavity section 57 of the dispenser 55. In this embodiment, the exhaust port 60 is located on an opposite side of the cavity section 57 to the outlet 59 and on the side wall 57a of the cavity section.

If the detector 80 shown in FIG. 6 is not to be received in the cavity section 57 of the dispenser, for example, because it may be too large or of a different geometry or technology which is not physically suitable for enclosing within the cavity section 57, then a bypass tube 61 may be provided as an alternative outlet means. Hence, the stimulus generated by the generator 10 can be expelled from the stimulus dispenser 55 through a further aperture, for example, by the action of the bypass tube to divert the stimulus generated by the generator in another direction as shown in FIG. 6, or provided on a sidewall 57a of the stimulus dispenser as shown in FIG. 6a. The other features are the same as the embodiment of FIG. 5. Note that the detector 80 in FIG. 6 is not drawn to scale relative to the dispenser and is only shown for example purposes to show its fixed location relative to the dispenser 55 which can be moved into position to test the detector 80.

The bypass tube in FIG. 6 can divert the stimulus vertically upwards towards a detector located above it. In one embodiment, it can be put up against a ‘flush’ detector i.e. one which is entirely flush with the ceiling and which has a ‘virtual’ smoke chamber in the space beneath it, where this bypass tube can introduce the stimulus. It can also be shaped to be able to sit around, for example, a sampling pipe (not shown) of an aspirating detection system (such as system is known in the art). The side walls of the dispenser 55 can be of a suitable length and may be relatively short to enable the sampling pipe of an aspirating smoke detection (ASD) system to lie across the bypass tube.

The bypass tube 61 can be any particular shape to connect the outlet to an appropriate exhaust location on the dispenser. In the embodiment shown in 6a, bypass tube 61a is L-shaped such that it is bent at 90 degrees to enable connection between an exhaust port 60 that is located 90 degrees from the outlet 59 (when the dispenser is viewed from above). As shown in FIG. 6a, the bypass tube 61a diverts the smoke out through one of the (two) exhaust ports 60 so that, for example, the smoke may be sampled by an ASD sampling point when the dispenser tool is held in the vicinity of the latter.

It should be noted, however, that the bypass tube may be straight if the exhaust port is located at 180 degrees to the outlet or any other appropriate shape. In the embodiment shown in FIG. 6, the exhaust port is in the approximate centre of the dispenser to direct the stimulus upwards out of a main aperture of the dispenser towards a hazard detector positioned above and outside of the dispenser cavity section. It may be movable to enable the outlet and exhaust port that are at different relative positions of to be connected such that stimulus can be directed towards a hazard detector located outside the dispenser cavity section.

Alternatively, the cavity section 57 can be removable and replaceable such that the normal cavity section of FIG. 5 can be swapped for an alternative cavity section that includes alternate means for stimulus exhaust according to the requirements of the hazard detector geometry, technology and size.

In an alternative embodiment shown in FIG. 7, the features are the same as the embodiment of FIG. 5 except the following. The outlet 59 of FIGS. 5 and 6 may instead be a rotatable outlet 59a such that the generated stimulus can be dispensed from a sidewall of dispenser adjacent the outlet 59a (instead of through a bypass tube). This can be achieved by providing an appropriate cutaway portion in the sidewall adjacent the outlet 59a to allow the outlet to be rotated 180 degrees and extend out from the sidewall.

In an embodiment (not shown), the cavity section shown in FIG. 5, 6 or 7 can be removed to permit the stimulus to exit directly from the outlet 59 to the detector 80 under test without introducing it to the cavity.

The control circuit 50 can control various aspects of the generating apparatus 10 such as the test medium delivery section 30 and stimulus generating section 20. It can also control the fan blower 70 of the stimulus dispenser 55 through appropriate electrical connections. The generating apparatus 10 will be electrically connected to the battery 65 such that power can be received therefrom through appropriate electrical connections. The circuit 50 preferably comprises one or more printed circuit boards which may include a controller (not shown) that is adapted to count the number of times the generating apparatus 10 is activated to provide test data such as to indicate the number of tests performed and/or influence the number of tests available and/or to determine any other information useful for testing purposes. The circuit 50 may further comprise an electronic data storage device to store useful data such as the test data and/or a safety cut-out mechanism for overheating protection.

In the above embodiments, a porous hollow tube is described. Alternatively, a porous fibre wick (e.g. multi-stranded fibreglass wick) can replace the hollow tube and the wick is connected to the tube 24. Such a configuration can obviate the need for a pumping apparatus 31.

In addition to the embodiments described in detail above, the skilled person will recognize that various features described herein can be modified and combined with additional features from the various embodiments, and the resulting additional embodiments are also within the scope of the invention.

1. Apparatus for generating a test stimulus for testing a hazard detector, the apparatus comprising:
a porous material for receiving a vaporisable test medium that is to be transported to surface of the porous material for vaporisation; and
an electrical heating device for heating the test medium on the surface of the porous material to generate a test stimulus for testing a hazard detector further comprising a tube which carries the test medium and wherein the porous material forms at least part of the tube.

2. The apparatus of claim 1, further comprising:
means for receiving a source of vaporisable test medium; and means for delivering the test medium to the porous material.

3. The apparatus of claim 2, wherein the source of vaporisable test medium is provided in a container.

4. The apparatus of claim 2, wherein one end of the delivering means is in contact with the source of vaporisable test medium and the other end is attached to the porous material such that test medium from the source of test medium is delivered to the porous material.

5. The apparatus of claim 1, wherein the electrical heating device is coupled to the porous material in order to heat the test medium received by the porous material and transported to its surface upon activation of the heating device.

6. The apparatus of claim 1, wherein the porous material is electrically non-conductive.

7. The apparatus of claim 1, wherein the porous material is thermally conductive.

8. The apparatus of claim 1, whereby in use, the porous material is impregnated with test medium.

9. The apparatus of any claim 1, wherein the porous material is fibreglass or ceramic.

10. The apparatus of claim 1, wherein the porous material has one or more holes in its surface.

11. The apparatus of claim 1, wherein the electrical device comprises an electrically conductive wire wound around an outer surface of the porous material.

12. The apparatus of claim 1, wherein the wire is electrically coupled to a control circuit.

13. The apparatus of claim 12 wherein the circuit is on a printed circuit board.

14. The apparatus of claim 2 wherein the means for receiving a source of vaporisable test medium comprises a piercing tube to connect to the test medium container.

15. Testing apparatus for testing a hazard detector, comprising
a dispenser comprising a pole, the dispenser further comprising a compartment for receiving a generating apparatus, wherein the generating apparatus is in the form of a module received in the compartment.

16. The testing apparatus of claim 15, further comprising a fan blower which is adapted to provide an air flow path to influence a flow of a test stimulus.

17. The testing apparatus of claim 16, wherein the generating apparatus comprises an accumulation area that is in fluid contact with the air flow path from the fan blower.

18. The testing apparatus of claim 15, further comprising a battery compartment for receiving a battery.

19. The testing apparatus according to claim 15, wherein the dispenser comprises an open-topped housing including a bottom and sidewall forming a cavity section for receiving a detector.

20. The testing apparatus of claim 19, wherein an outlet is positioned in the cavity section and an exhaust port is located in the cavity section of the dispenser to allow any excess generated stimulus to be exhausted from the cavity section of the dispenser.

21. The testing apparatus of claim 20, wherein cavity section is removable and replaceable such that the cavity section can be swapped for an alternative cavity section to provide alternative means for stimulus exhaust from the alternative cavity section.

22. The testing apparatus of claim 19, wherein the alternative cavity section is shaped according to the requirements of the hazard detector geometry, technology and size.

23. The testing apparatus of claim 19, wherein an outlet is positioned in the cavity section, the sidewall of the cavity section including a cut out portion, wherein the outlet is rotatable within the cut out portion.

24. (canceled)
